(19) United States
(12) Patent Application Publication
(10) Pub. No.: US 2013/0291661 A1
(43) Pub. Date: Nov. 7, 2013

(54) ERROR DISPLAY DEVICE AND ERROR DISPLAY METHOD

(71) Applicants: Ryuta Sato, Chiyoda-ku (JP); Kotaro Nagaoka, Chiyoda-ku (JP); Shunro Ono, Chiyoda-ku (JP)

(72) Inventors: Ryuta Sato, Chiyoda-ku (JP); Kotaro Nagaoka, Chiyoda-ku (JP); Shunro Ono, Chiyoda-ku (JP)

(73) Assignee: MITSUBISHI ELECTRIC CORPORATION, Chiyoda-ku, Tokyo (JP)

(21) Appl. No.: 13/977,958

(22) PCT Filed: Jan. 26, 2011
(86) PCT No.: PCT/JP2011/051520

§ 371 Date: Jul. 2, 2013

(51) Int. Cl. B23Q 17/00

(52) U.S. Cl. CPC B23Q 17/00
USPC 73/865.9

(57) ABSTRACT

An error display device is a device for displaying a translation error and an attitude error associated with a rectilinear motion of a machine element, and includes a reference-motion-trajectory display unit that displays a design motion trajectory, and an error magnification/display unit that magnifies the translation error and the attitude error and displays the magnified errors, wherein the error magnification/display unit calculates a translation error vector including a magnified translation error obtained by multiplying the translation error by a predetermined magnification factor, draws a translation error trajectory including the design motion trajectory and the translation error vector added thereto, calculates an attitude error matrix including a magnified attitude error obtained by multiplying the attitude error by a predetermined magnification factor, and draws a predetermined shape with coordinates transformed using the attitude error matrix and the translation error vector.

### FIELD

The present invention relates to an error display device and an error display method that enable to magnify an assembly error of a machine element, for example, in a machine tool or a robot, or an error associated with a motion thereof and to display the error in a recognizable manner.

### BACKGROUND

For example, in a machine tool, a plurality of movable shafts is moved one by one or at a time to create a three-dimensional shape. It is known that, when the movable shafts are moved, guide faces that guide motions of the movable shafts, a geometric accuracy in a drive mechanism, a sensor accuracy to be used for a feedback control, an interaction between a drive force and a reaction force thereto, or the like causes an error in design position and attitude.

Non Patent Literature 1 discloses errors resulting from a motion of a machine element and several measurement methods therefor. For example, a machine element (a rectilinear axis) that performs a rectilinear motion includes three translation errors and three attitude errors, that is, errors in a total of six degrees of freedom. A machine element (a rotation axis) that performs a rotational motion includes errors such as an error in a design position of a rotation center line and a tilt of the rotation center line.

Patent Literature 1 discloses a method for measuring assembly errors such as a position and a tilt of a rotation center line, and the like. In this method, while a distance between two balls of a ball bar is kept constant, a geometric error in a rotation axis is obtained based on an amount of eccentricity in measurement data that is obtained by measuring a motion of the ball bar rotating around the center line of a pivot shaft on a condition in which a sensitivity direction of the ball bar is kept in a shaft direction with respect to the pivot shaft and on a condition in which the sensitivity direction is kept in a radial direction.

### CITATION LIST

### Patent Literature

Patent Literature 1: Japanese Patent Application Laid-open No. 2004-219132

### Non Patent Literature

Non Patent Literature 1: DRAFT INTERNATIONAL STANDARD ISO/DIS 230-1, Test code for machine tools—Part 1: Geometric accuracy of machines operating under no-load or quasi—static conditions (2010).

### SUMMARY

### Technical Problem

A primary object of measurement of an error is to confirm that the error included in a machine tool falls within a predetermined acceptable error range. However, as a secondary object, mechanical modification may be performed based on a measurement result of the error, or correction may be performed through input of measured error data to a numerical control device. Particularly, the importance of the correction to the numerical control device is increased because recent evolutions of the numerical control device enable advanced correction.

To perform the mechanical modification or the correction by the numerical control device based on the error measurement result, it is necessary to know what is an error included in the machine. However, according to the method disclosed in Non Patent Literature 1 or Patent Literature 1, the measurement result is represented by a one-dimensional graph or a numerical value and cannot be understood intuitively. Furthermore, there is no specific method for displaying an attitude error.

The present invention has been achieved in view of the above problems, and an object of the present invention is to provide an error display device and an error display method that enable to display characteristics of a motion error included in a rectilinear axis of a machine or a position and a tilt of the center line of a rotation axis in a visually recognizable manner and that enable intuitive understanding of meaning of the error.

### Solution to Problem

To solve the above problems and achieve an object, there is provided an error display device according to the present invention for displaying a translation error and an attitude error associated with a rectilinear motion of a machine element, the error display device including: a reference-motion-trajectory display unit that displays a design motion trajectory; and an error magnification/display unit that magnifies the translation error and the attitude error and displays the magnified errors, wherein the error magnification/display unit calculates a translation error vector including a magnified translation error obtained by multiplying the translation error by a predetermined magnification factor, and draws a translation error trajectory including the design motion trajectory and the translation error vector added thereto, and calculates an attitude error matrix including a magnified attitude error obtained by multiplying the attitude error by a predetermined magnification factor, and draws a predetermined shape with coordinates transformed using the attitude error matrix and the translation error vector.

There is further provided an error display device according to the present invention that displays a position and a tilt of a rotation-axis center line of a rotation axis of a machine element, the error display device including: a reference-center-line display unit that draws a design center line of the rotation axis as a reference center line with a predetermined length of a line segment; and an error magnification/display unit that draws an error-magnified center line including an assembly error magnified, wherein the error magnification/display unit calculates a translation error vector including a magnified translation error obtained by multiplying a translation error by a predetermined magnification factor, and calculates an attitude error matrix including a magnified attitude error obtained by multiplying an attitude error by a predetermined magnification factor, and draws a line segment, which is,obtained by transforming coordinates of the reference center line using the attitude error matrix and the translation error vector, as the error-magnified center line.

To solve the above problems and achieve an object, there is provided an error display method according to the present invention for displaying a translation error and an attitude error associated with a rectilinear motion of a machine element, the error display method including: a reference-motion-trajectory display step of displaying a design motion trajectory; and an error magnification/display step of magnifying the translation error and the attitude error and displaying the magnified errors, wherein at the error magnification/display step, a translation error vector including a magnified translation error obtained by multiplying the translation error by a predetermined magnification factor is calculated, and a translation error trajectory including the design motion trajectory and the translation error vector added thereto is drawn, and an attitude error matrix including a magnified attitude error obtained by multiplying the attitude error by a predetermined magnification factor is calculated, and a predetermined shape with coordinates transformed using the attitude error matrix and the translation error vector is drawn.

There is further provided an error display method according to the present invention of displaying a position and a tilt of a rotation-axis center line of a rotation axis of a machine element, the error display method including: a reference-center-line display step of drawing a design center line of the rotation axis as a reference center line with a predetermined length of a line segment; and an error magnification/display step of drawing an error-magnified center line including an assembly error magnified, wherein at the error magnification/display step, a translation error vector including a magnified translation error obtained by multiplying a translation error by a predetermined magnification factor is calculated, and an attitude error matrix including a magnified attitude error obtained by multiplying an attitude error by a predetermined magnification factor is calculated, and a line segment obtained by transforming coordinates of the reference center line using the attitude error matrix and the translation error vector is drawn as the error-magnified center line.

### Advantageous Effects of Invention

While an error measurement result is displayed as a numerical value in the conventional technique, which prevents physical meaning of the error from being correctly understood, and thus a proper measure for improving a machining accuracy is not provided with a machine tool or the like, the error display device and the error display method according to the present invention can visually display an error in such a manner that meaning of the error can be intuitively understood. This enables a designer or a user to clearly recognize an improvement effect in a machining accuracy by correction or mechanical modification of the error. This contributes to greatly enhance the machining accuracy for a long term.

### BRIEF DESCRIPTION OF DRAWINGS

FIG. 1 is an explanatory diagram of an error in six degrees of freedom of a rectilinear axis.

FIG. 2 is an explanatory diagram of a method of magnifying an error in a rectilinear axis and displaying the magnified error, and is a flowchart of procedures of an operation performed by an error display device according to a first embodiment.

FIG. 3 is an explanatory diagram of error data of a rectilinear axis.

FIG. 4 is an example in the first embodiment in which errors of rectilinear axes are magnified and displayed on a three-dimensional perspective graph.

FIG. 5 is an explanatory diagram of assembly errors in rotation axes.

FIG. 6 is an explanatory diagram of a method of magnifying and displaying assembly errors in rotation axes, and is a flowchart of procedures of an operation performed by an error display device according to a second embodiment.

FIG. 7 is an explanatory diagram of data of assembly errors in rotation axes.

FIG. 8 is an example in the second embodiment in which assembly errors in rotation axes of a rotary-table type are magnified and displayed on a three-dimensional perspective graph.

FIG. 9 is an example in the second embodiment in which assembly errors in rotation axes of a mixed type are magnified and displayed on a three-dimensional perspective graph.

FIG. 10 is an example in the second embodiment in which assembly errors in rotation axes of a spindle-head rotary type are magnified and displayed on a three-dimensional perspective graph.

### DESCRIPTION OF EMBODIMENTS

Exemplary embodiments of an error display device and an error display method according to the present invention will be explained below in detail with reference to the accompanying drawings. The present invention is not limited to the embodiments.

### First Embodiment

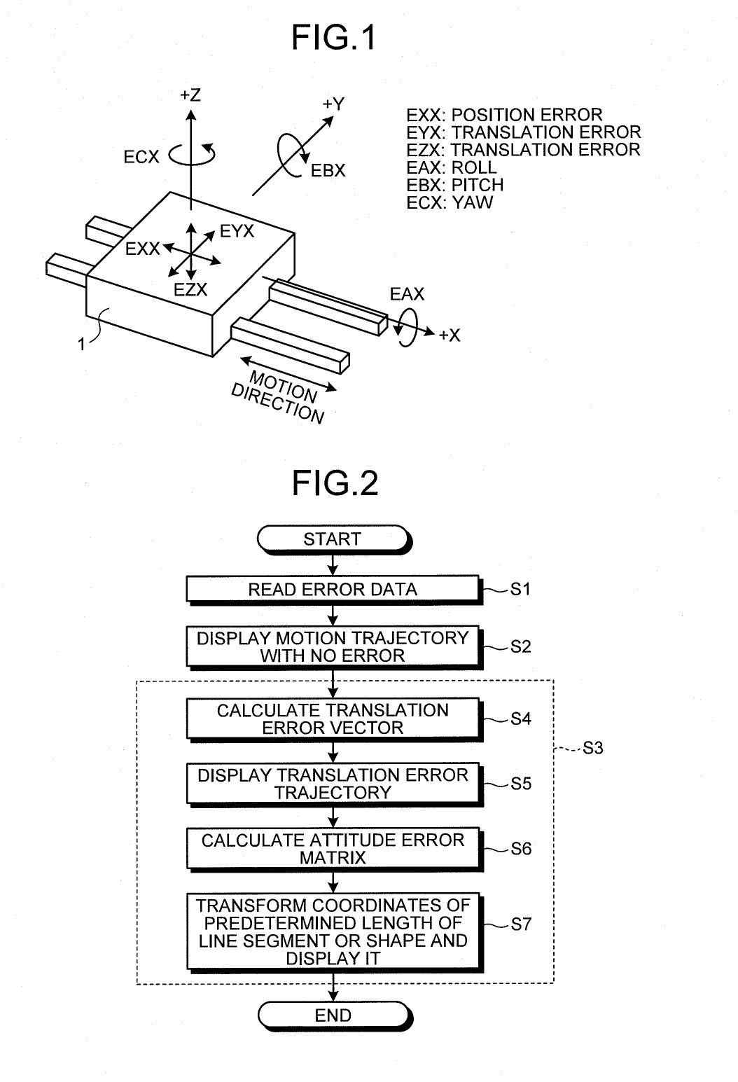

As an exemplary embodiment of the present invention, a method of displaying errors in six degrees of freedom associated with a motion along a rectilinear axis of a machine tool is explained. There are three translation errors and three attitude errors, that is, errors in a total of six degrees of freedom in a machine element 1 that performs a rectilinear motion as shown in FIG. 1. In FIG. 1, EXX denotes a position error, EYX denotes a translation error, EZX denotes a translation error, EAX denotes a roll, EBX denotes a pitch, and ECX denotes a yaw. It is known that these errors result from geometric accuracies in a guide face that guides the rectilinear motion and a drive mechanism, a sensor accuracy to be used for a feedback control, an interaction between a drive force and a reaction force thereto, and the like.

An error display method according to the present embodiment is explained with reference to FIG. 2. FIG. 2 is an explanatory diagram of a method of magnifying an error in a rectilinear axis and displaying the magnified error, and is a flowchart of procedures of an operation performed by an error display device according to the present embodiment. The error display device includes an operation program in which the procedures shown in FIG. 2 are described and a central processing unit (CPU) that executes the operation program, and operates according to the procedures shown in FIG. 2. Parts in which the procedures of the operation program are described and the CPU that performs the procedures constitute units that perform operations of the procedures, respectively. The error display device according to the present embodiment operates in procedures of an error-data reading step S1, a reference-motion-trajectory display step (reference-motion-trajectory display unit) S2, and an error magnification/display step (error magnification/display unit) S3. The error magnification/display step S3 includes procedures of a translation-error-vector calculating step S4, a translation-error-trajectory display step S5, an attitude-error-matrix calculating step S6, and an attitude-error display step S7.

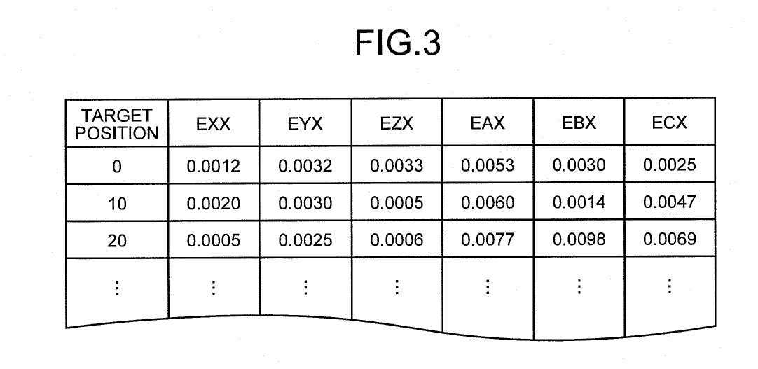

At the error-data reading step S1, numerical data showing errors in six degrees of freedom in the rectilinear axis is read. Images of error data are shown in FIG. 3. Error data of the rectilinear axis is represented as numerical values of six error components at a plurality of target positions. The target positions are generally set at equal distances within a stroke of the rectilinear axis. When there is a plurality of rectilinear axes, there is similar error data corresponding to each of the rectilinear axes and a perpendicularity between respective two axes is also read as a numerical value.

A method using a straightedge and a dial gauge, a method with a laser length-measuring machine, and a measurement method with a laser tracker are known as methods for measuring the error data as shown in FIG. 3. As can be understood from FIG. 3, whether the maximum error amount is within an acceptable value can be determined based on the error data; however, how the rectilinear axis behaves cannot be read.

First, at the reference-motion-trajectory display step S2, a design motion trajectory of the rectilinear axis is displayed. In the case of a rectilinear axis, the trajectory is a straight line parallel to a motion direction of the rectilinear axis and the length thereof is a movable range (a stroke) of the rectilinear axis. When plural rectilinear axes are arranged to intersect with each other, a plurality of intersected lines is displayed.

Next, at the error magnification/display step S3, the error data read at the error-data reading step S1 is magnified and displayed on the reference motion trajectory displayed at the reference-motion-trajectory display step S2. An error is generally of an order of several micrometers or a thousandth of a degree and accordingly the error is magnified by a magnification factor of 100 to 1000 to be visually recognized. A process of the error magnify/display step S3 is explained in detail.

First, at the translation-error-vector calculating step S4, a translation error vector eₜᵣₐₙₛ is calculated according to the following expression 1. While the expression 1 is an example in a case where the rectilinear axis is an X-axis, similar calculation can be performed also in a case where the rectilinear axis is a Y-axis or a Z-axis. In this expression, K is an error magnification factor and n is a target position number.

$${e}_{trans} ( n ) = K [ \begin{matrix}EXX ( n ) \\ EYX ( n ) \\ EZX ( n )\end{matrix} ] \qquad ( Expression 1 )$$

At the translation-error-trajectory display step S5, a translation error position xₑ is obtained by adding the translation error vector to the target position according to an expression 2, and adjacent translation errors are connected with a line segment to display a translation error trajectory. In this expression, x(n) is a target position vector, which is ^{t}[x(n)0 0] when the rectilinear axis is the X-axis.

[Expression 2]

xₑ(n)=x(n)+eₜᵣₐₙₛ(n) (Expression 2)

At the attitude-error-matrix calculating step S6, an attitude error matrix Aₜᵣₐₙₛ is calculated according to the following expression 3 based on the error data read at the error-data reading step S1. In the expression 3, the sine and the cosine are approximated assuming that each attitude error is minute. While the expression 3 is an example in the case where the rectilinear axis is the X-axis, similar calculation can be performed also in a case where the rectilinear axis is the Y-axis or Z-axis. In this expression, K is an error magnification factor, which can be the same value as that in the expression 1 or can be different therefrom, and n is a target position number.

$${A}_{trans} ( n ) = [ \begin{matrix}1 & - K \cdot EXC ( n ) & K \cdot EBX ( n ) \\ K \cdot ECX ( n ) & 1 & - K \cdot EAX ( n ) \\ - K \cdot EBX ( n ) & K \cdot EAX ( n ) & 1\end{matrix} ] \qquad ( Expression 3 )$$

At the attitude-error display step S7, coordinates of a predetermined line segment or a predetermined shape are transformed using the translation error vector of the expression 1 and the attitude error matrix of the expression 3, and are displayed on the reference motion trajectory displayed at the reference-motion-trajectory display step S2. When coordinates of a point group representing a predetermined line segment or a predetermined shape located at the coordinate origin are ^{t}[dx(m) dy(m) dz(m)], coordinates ^{t}[dxe(n, m) dye(n, m) dze(n, m)] of a point group de representing the predetermined line segment or the predetermined shape in consideration of the magnified translation error and the magnified attitude error at the nth target position are calculated according to the following expression 4.

$$[ \begin{matrix}dxe ( n , m ) \\ dye ( n , m ) \\ dze ( n , m )\end{matrix} ] = x ( n ) + {e}_{trans} ( n ) + {A}_{trans} ( n ) [ \begin{matrix}dx ( m ) \\ dy ( m ) \\ dz ( m )\end{matrix} ] \qquad ( Expression 4 )$$

At the attitude-error display step S7, coordinates of the point group de at at least two target positions with respect to each rectilinear axis are calculated and adjacent points of the point group are connected by a line segment to display the predetermined line segment or the predetermined shape with the magnified translation error and the magnified attitude error on the reference motion trajectory displayed at the reference-motion-trajectory display step S2.

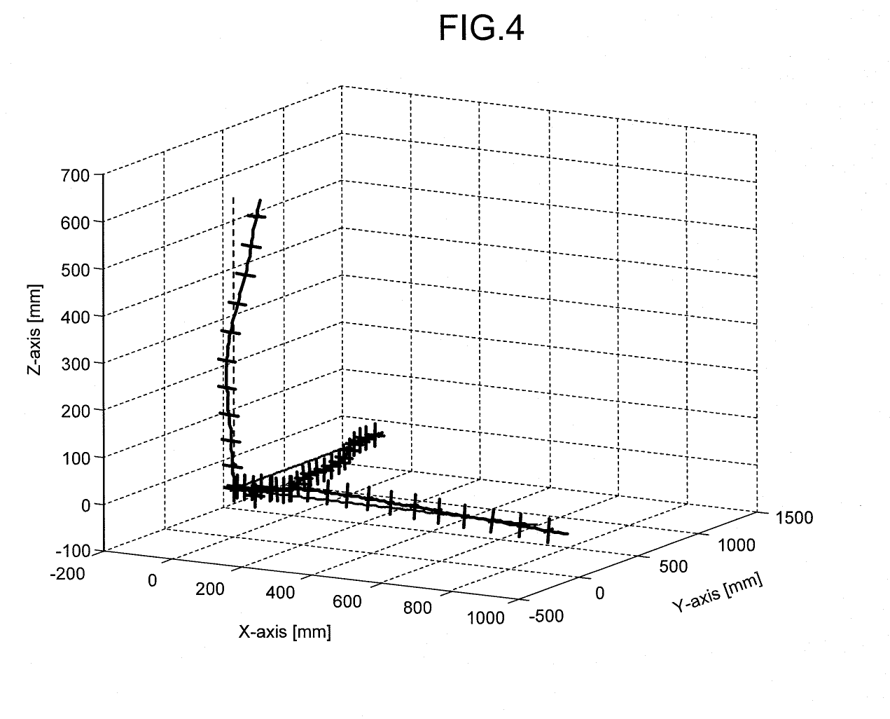

An example of error data of rectilinear axes displayed according to the present embodiment is shown in FIG. 4. In FIG. 4, a design motion trajectory is represented by a thin line, and magnified translation errors and magnified attitude errors are represented by thick lines. In this example, a line segment is used as a predetermined shape representing an attitude error. That is, the attitude errors are displayed, at equal distances, with line segments intersecting with motion directions of the rectilinear axes. As shown in FIG. 4, the error display method according to the present embodiment enables to visually display both of the translation errors and the attitude errors on a three-dimensional perspective graph.

As described above, the error display device and the error display method according to the present embodiment enable to display motion errors in six degrees of freedom of a machine element that performs a rectilinear motion as motion trajectories thereof, and attitudes of a line segment or a predetermined shape on a three-dimensional perspective graph. Therefore, characteristics of the motion errors which a rectilinear axis of a machine has can be intuitively understood. Accordingly, causes of a poor accuracy during machining can be examined. Furthermore, the attitude error matrix and the translation error vector are calculated at at least two points with respect to one movable axis to draw a predetermined line segment or a predetermined shape, so that changes in the attitude error associated with the motion can be visually displayed.

### Second Embodiment

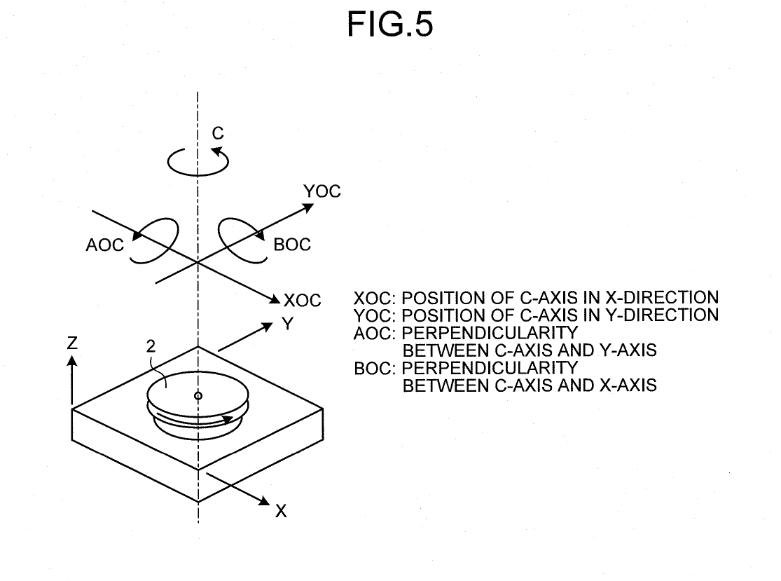

As a second embodiment of the present invention, a method for displaying assembly errors in rotation axes of a rotary-table-type 5-axis machine tool having an A-axis and a C-axis on the side of a table is explained as an example. Assembly errors present in the C-axis are explained first with reference to FIG. 5. In FIG. 5, XOC denotes a position of the C-axis in an X-direction, YOC denotes a position of the C-axis in a Y-direction, AOC denotes a perpendicularity between the C-axis and the Y-axis, and BOC denotes a perpendicularity between the C-axis and the X-axis. Assembly errors in a rotation axis (a machine element 2 that performs a rotational motion) are represented by a position and a tilt of the center line of the rotation axis. For example, in the case of the C-axis, there are translation errors in the X-axis direction and in the Y-axis direction and attitude errors around the X-axis and around the Y-axis. There are four assembly error components with respect to one rotation axis. When there are two rotation axes, the number of parameters representing assembly errors in the rotation axes is eight in total.

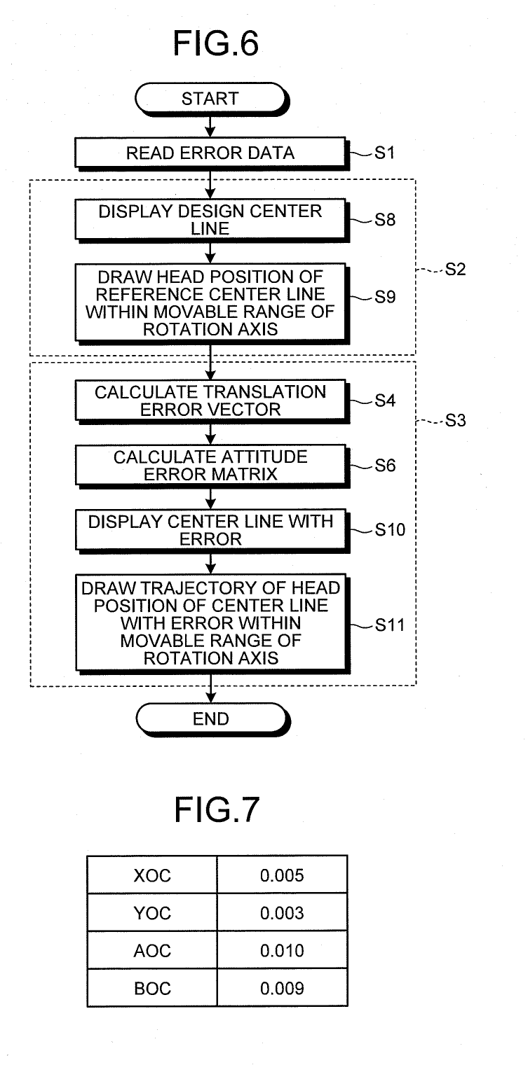

A method for displaying assembly errors in rotation axes according to the present invention is explained with reference to FIG. 6. FIG. 6 is an explanatory diagram of a method of magnifying and displaying assembly errors in rotation axes, and is a flowchart of procedures of an operation performed by an error display device according to the present embodiment. The error display device includes an operation program in which the procedures shown in FIG. 6 are described and a CPU that executes the operation program, and operates according to the procedures shown in FIG. 6. Parts in which the procedures of the operation program are described and the CPU that performs the procedures constitute units that perform operations of the procedures, respectively. The error display device according to the present embodiment operates in procedures of the error-data reading step S1, the reference-motion-trajectory display step (reference-motion-trajectory display unit) S2, and the error magnification/display step (error magnification/display unit) S3. The reference-motion-trajectory display step S2 includes procedures of a reference-center-line display step (reference-center-line display unit) S8 and a reference head-position-trajectory drawing step S9. The error magnification/display step S3 includes procedures of the translation-error-vector calculating step S4, the attitude-error-matrix calculating step S6, an error-magnified center-line display step S10, and an error-magnified head-position-trajectory drawing step S11.

At the error-data reading step S1, numerical data showing assembly errors in the rotation axes is read. Images of error data are shown in FIG. 7. Assembly errors in a rotation axis are represented as four numerical values of positions and angles with respect to one rotation axis. As can be understood from FIG. 7, even when assembly errors in the rotation axis are represented as numerical values, what the values mean cannot be intuitively understood.

A method using a ball bar, a method using a ball and a displacement meter, a method using a straightedge or a cylinder speed square and a displacement meter, and the like are known as methods of measuring assembly errors in rotation axes.

At the reference-center-line display step S8, a design center line of each of the rotation axes in a case where there is no assembly error is displayed. Coordinates of both ends of line segments showing the center line of rotation around the A-axis and the center line of rotation around the C-axis in the case where there is no assembly error are represented by expressions 5 and 6, respectively, when a length of the center line is 2 L and a vector showing coordinates of an intersection between the A-axis center line and the C-axis center line is ^{M}X_{c}.

$$\begin{matrix}[ \begin{matrix}{x}_{A +} \\ {y}_{A +} \\ {z}_{A +}\end{matrix} ] = {}_{}^{M}{x}{}_{C}^{} + [ \begin{matrix}L \\ 0 \\ 0\end{matrix} ] , [ \begin{matrix}{x}_{A -} \\ {y}_{A -} \\ {z}_{A -}\end{matrix} ] = {}_{}^{M}{x}{}_{C}^{} - [ \begin{matrix}L \\ 0 \\ 0\end{matrix} ] & ( Expression 5 ) \\ [ \begin{matrix}{x}_{C +} \\ {y}_{C +} \\ {z}_{C +}\end{matrix} ] = {}_{}^{M}{x}{}_{C}^{} + {R}_{A} [ \begin{matrix}0 \\ 0 \\ L\end{matrix} ] , [ \begin{matrix}{x}_{C -} \\ {y}_{C -} \\ {z}_{C -}\end{matrix} ] = {}_{}^{M}{x}{}_{C}^{} - {R}_{A} [ \begin{matrix}0 \\ 0 \\ L\end{matrix} ] & ( Expression 6 )\end{matrix}$$

In this expression, R_{A} is a rotation matrix for rotating coordinates around the A-axis and is represented by an expression 7. In this expression, q_{A} is a rotation angle of the A-axis and, because the A-axis is arranged on the side of the table, the sign is negative.

$${R}_{A} = [ \begin{matrix}1 & 0 & 0 \\ 0 & cos ( - {θ}_{A} ) & - sin ( - {θ}_{A} ) \\ 0 & sin ( - {θ}_{A} ) & cos ( - {θ}_{A} )\end{matrix} ] \qquad ( Expression 7 )$$

At the reference-center-line display step S8, the coordinates of the both ends of the line segment representing the A-axis center line are calculated according to the expression 5 to display a line segment connecting the both ends, and the coordinates of the both ends of the line segment representing the C-axis center line in a state where the A-axis rotation angle is zero in the expression 7 are calculated according to the expression 6 to display a line segment connecting the both ends.

Furthermore, a rotation angle of a rotation axis on the root side leads to a change in the direction of a rotation-axis center line of another rotation axis supported by the root-side rotation axis, in the case of the rotation axis of the rotary-table-type 5-axis machine tool cited as an example in the present embodiment. In this case, a trajectory of a head of the center line of another one rotation axis, the trajectory being associated with the motion of the rotation axis on the root side, is drawn at the reference head-position-trajectory drawing step S9.

The case of the present embodiment in which the rotation axis on the root side is the A-axis and the rotation axis on the table side is the C-axis is specifically explained. The A-axis rotation angle in the expression 7 is changed at a predetermined interval within a movable range of the A-axis, a head position of a line segment representing the C-axis center line at each of the A-axis angles is calculated according to the expression 6, and adjacent head positions are connected by a line segment, so that a trajectory of the head position of the line segment representing the C-axis center line is drawn. In the case of the rotary-table type, a trajectory can be understood more intuitively when a trajectory of a head on the positive side is drawn than when a trajectory of a head on the negative side is drawn.

At the error magnification/display step S3, the error data read at the error-data reading step S1 is magnified and displayed on the reference center line displayed at the reference-center-line display step S8. An error is generally of an order of several micrometers or a thousandth of a degree. Therefore, the error needs to be magnified by a factor of 100 to 1000 to be visually recognized. A process of the error magnification/display step S3 is explained in detail.

First, at the translation-error-vector calculating step S4, a translation error vector of each of the rotation axes is calculated based on the error data read at the error-data reading step S1. The translation error vector of a rotation axis is shown as a difference from a design center position of rotation. In the case of the A-axis and the C-axis, for example, the corresponding translation error vectors are represented by expressions 8 and 9, respectively. In these expressions, K is an error magnification factor.

e_{A}=^{t}[0 K·Y0A K·Z0A] (Expression 8)

e_{C}=^{t}[K·X0C K·Y0C 0] (Expression 9)

Next, at the attitude-error-matrix calculating step S6, an attitude error matrix of each of the rotation axes is calculated based on the error data read at the error-data reading step S1. For example, in the case of the A-axis and the C-axis, the attitude error matrices are represented by expressions 10 and 11, respectively. In the expressions 10 and 11, the sine and the cosine are approximated assuming that each attitude error is minute. K is an error magnification factor, which can be the same value as in the expressions 8 and 9 or can be different therefrom.

$$\begin{matrix}{A}_{A} = [ \begin{matrix}1 & - K \cdot C 0 A & K \cdot B 0 A \\ K \cdot C 0 A & 1 & 0 \\ - K \cdot B 0 A & 0 & 1\end{matrix} ] & ( Expression 10 ) \\ {A}_{C} = [ \begin{matrix}1 & 0 & K \cdot B 0 C \\ 0 & 1 & - K \cdot A 0 C \\ - K \cdot B 0 C & K \cdot A 0 C & 1\end{matrix} ] & ( Expression 11 )\end{matrix}$$

At the error-magnified center-line display step S10, the rotation center line with a magnified assembly error is then displayed. Coordinates of both ends of line segments representing the center line of the A-axis rotation and the center line of the C-axis rotation with magnified assembly errors are represented by expressions 12 and 13, respectively. A length of the center line is 2 L. A vector representing coordinates of an intersection between the A-axis center line and the C-axis center line is ^{M}X_{c}.

$$\begin{matrix} [ \begin{matrix}{x}_{A +} \\ {y}_{A +} \\ {z}_{A +}\end{matrix} ] = {}_{}^{M}{x}{}_{C}^{} + {e}_{A} + {A}_{A} [ \begin{matrix}L \\ 0 \\ 0\end{matrix} ] , \\ [ \begin{matrix}{x}_{A -} \\ {y}_{A -} \\ {z}_{A -}\end{matrix} ] = {}_{}^{M}{x}{}_{C}^{} + {e}_{A} - {A}_{A} [ \begin{matrix}L \\ 0 \\ 0\end{matrix} ] & ( Expression 12 ) \\ [ \begin{matrix}{x}_{C +} \\ {y}_{C +} \\ {z}_{C +}\end{matrix} ] = {}_{}^{M}{x}{}_{C}^{} + K [ \begin{matrix}X 0 C \\ Y 0 A \\ Z 0 A\end{matrix} ] + {R}_{Ae} \{ \begin{matrix}K [ \begin{matrix}0 \\ Y 0 C - Y 0 A \\ 0\end{matrix} ] + \\ {A}_{C} [ \begin{matrix}L \\ 0 \\ 0\end{matrix} ]\end{matrix} \} \\ [ \begin{matrix}{x}_{C -} \\ {y}_{C -} \\ {z}_{C -}\end{matrix} ] = {}_{}^{M}{x}{}_{C}^{} ++ K [ \begin{matrix}X 0 C \\ Y 0 A \\ Z 0 A\end{matrix} ] + {R}_{Ae} \{ \begin{matrix}K [ \begin{matrix}0 \\ Y 0 C - Y 0 A \\ 0\end{matrix} ] - \\ {A}_{C} [ \begin{matrix}L \\ 0 \\ 0\end{matrix} ]\end{matrix} \} & ( Expression 13 )\end{matrix}$$

In these expressions, R_{Ae} is a rotation matrix for rotating coordinates around the A-axis with an error and is represented by an expression 14. In this case, θ_{A} is a rotation angle of the A-axis and, because the A-axis is arranged on the table side, the sign is negative.

$${R}_{Ae} = [ \begin{matrix}1 & \begin{matrix}C 0 A ( 1 - cos ( - {θ}_{A} ) ) + \\ B 0 A sin ( - {θ}_{A} )\end{matrix} & \begin{matrix}- B 0 A ( 1 - cos ( - {θ}_{A} ) ) + \\ C 0 A sin ( - {θ}_{A} )\end{matrix} \\ \begin{matrix}C 0 A ( 1 - cos ( - {θ}_{A} ) ) - \\ B 0 A sin ( - {θ}_{A} )\end{matrix} & cos ( - {θ}_{A} ) & - sin ( {θ}_{A} ) \\ \begin{matrix}- B 0 A ( 1 - cos ( - {θ}_{A} ) ) - \\ C 0 A sin ( - {θ}_{A} )\end{matrix} & sin ( - {θ}_{A} ) & cos ( - {θ}_{A} )\end{matrix} ] \qquad ( Expression 14 )$$

At the error-magnified center-line display step S10, coordinates of both ends of a line segment representing the A-axis center line are calculated according to the expression 12 to display the line segment connecting the both ends, and coordinates of a line segment representing the C-axis center line in a state where the A-axis rotation angle in the expression 14 is zero are calculated according to the expression 13 to display the line segment connecting the both ends.

Furthermore, when an angle of a rotation axis on the root side leads to a change in the direction of the rotation-axis center line on a rotation axis located on the root-side rotation axis, as in the rotation axis of the rotary-table-type 5-axis machine tool cited as an example in the present embodiment, a trajectory of the head of the center line of another rotation axis associated with the motion of the rotation axis on the root side is drawn at the error-magnified head-position-trajectory drawing step S11.

To specifically explain a case where the rotation axis on the root side is the A-axis and the rotation axis on the table side is the C-axis, the A-axis rotation angle in the expression 14 is changed at a predetermined interval within a movable range of the A-axis, a head position of a line segment representing a C-axis center line at each of the A-axis angles is calculated according to the expression 13, and adjacent head positions are connected by a line segment, thereby drawing a trajectory of the head position. In the case of the rotary-table type, a trajectory can be more intuitively understood when a trajectory of a head position on the positive side is drawn.

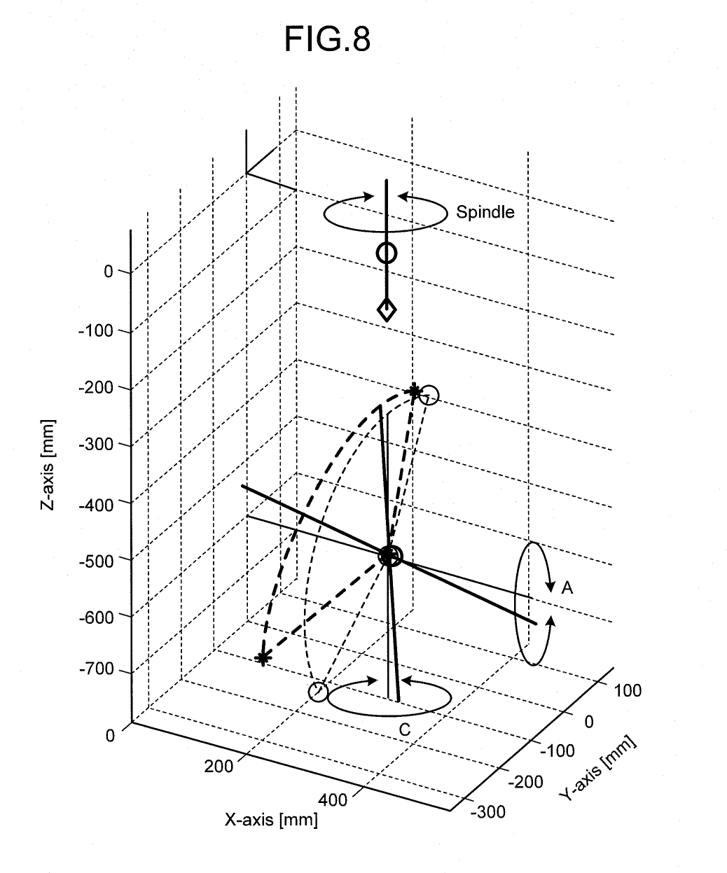

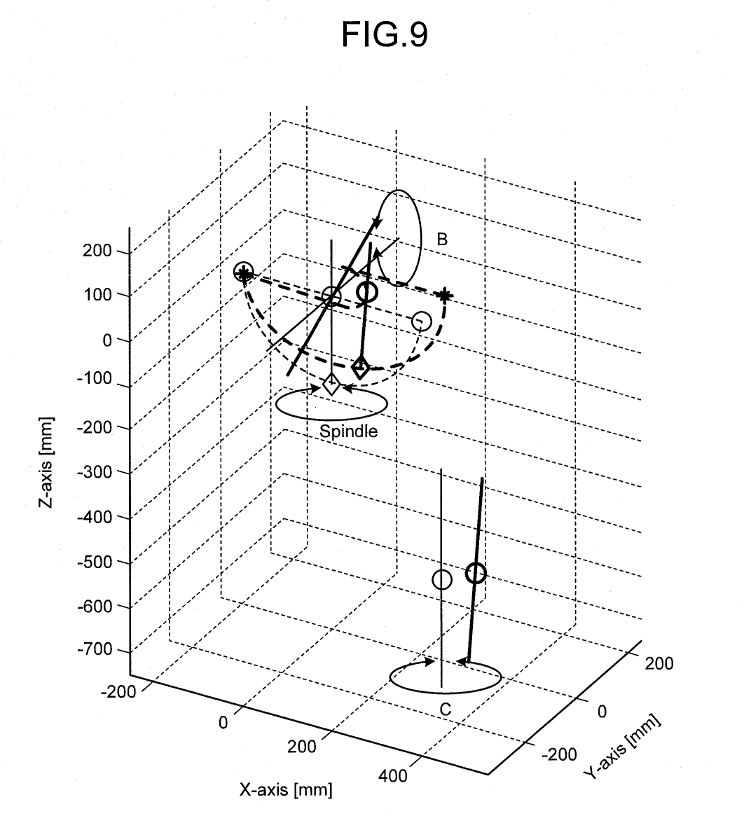

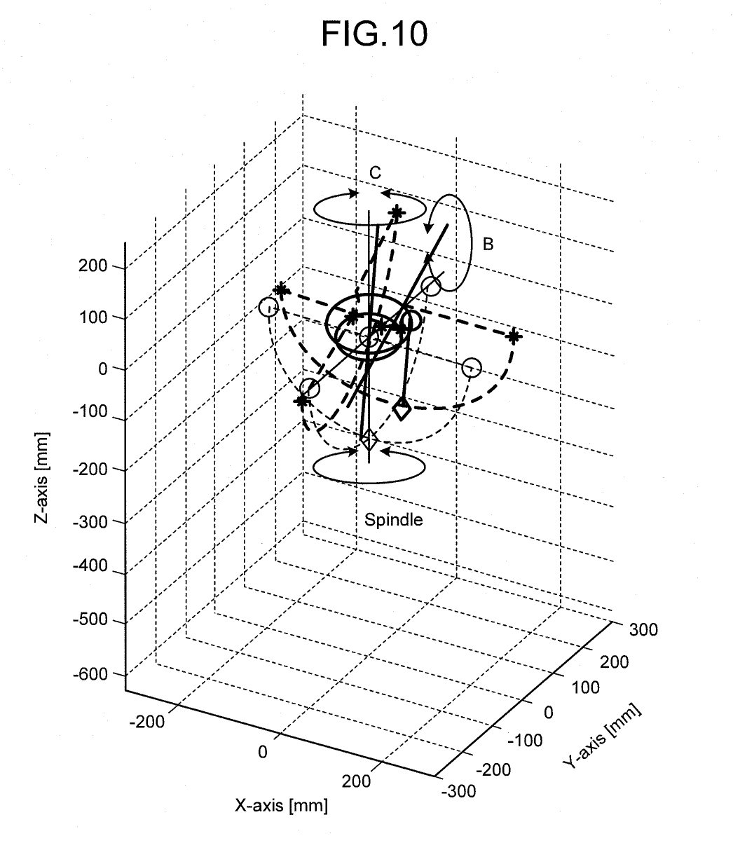

An example in which assembly errors in the rotation axes of the rotary-table-type 5-axis machine tool having the A-axis and the C-axis on the table side, which is cited as an example of the present embodiment are displayed on a three-dimensional perspective graph is shown in FIG. 8. In FIG. 8, center lines of the rotation axes with no error and a trajectory of a head position of the center line are represented by thin lines, and center lines of the rotation axes with errors and a trajectory of the head position of the center line are represented by thick lines. Also in FIGS. 9 and 10 explained later, trajectories with no error are represented by thin lines and trajectories with errors are. As can be understood from FIG. 8, by displaying the trajectories with no error and the trajectories with errors side by side on the same three-dimensional perspective graph to indicate directions and magnitudes of the errors, errors such as the position and the tilt of each of the rotation-axis center lines can be displayed in an visually understandable manner. Furthermore, by rotating the A-axis, an influence of the tilt of the A-axis center line appears large and it is found that deviation from the case where there is no error becomes large.

In this way, by the error display method according to the present embodiment, the states of assembly errors such as the position and the tilt of the center line of the rotation axis can be visually displayed and therefore characteristics of the assembly errors included in rotation axes of a machine can be intuitively understood. Accordingly, correction of the assembly errors or examination of causes of a poor accuracy during machining can be performed.

Furthermore, by the error display method according to the present embodiment, when a motion of a rotation axis on the root side leads to a change in the direction of the rotation center line of another rotation axis mounted to the root-side rotation axis, a behavior of the center line with an error when the center line is rotated can be visually displayed around the rotation axis with an error. By doing so, degrees of influences of assembly errors in the plural rotation axes can be recognized and errors that are to be strictly adjusted and errors that do not need to be strictly adjusted can be distinguished.

While the present embodiment has been explained above with the example of the rotary-table-type 5-axis machine tool having the A-axis and the C-axis on the table side, the applicable range of the present invention is not limited thereto. An example in which assembly errors in rotation axes of a mixed-type 5-axis machine tool having the C-axis on the table side and the B-axis on the spindle side are displayed on a three-dimensional perspective graph by the error display method according to the present embodiment is shown in FIG. 9.

In the mixed-type 5-axis machine tool or a 4-axis machine tool having one rotation axis on the table side, the direction of a center line of the rotation axis on the table side is fixed. When an assembly error in the rotation axis on the table side is to be displayed, the reference head-position-trajectory drawing step S9 and the error-magnified head-position-trajectory drawing step Sll are not performed.

A rotational motion of the B-axis as the rotation axis arranged on the spindle side changes the direction of a center line of the spindle as another rotation axis. In such a case, the B-axis with no error and the spindle center line with no error, and a trajectory of a head position of the center line in a case where the spindle center line with no error is rotated around the B-axis center line with no error are drawn (thin lines in FIG. 9) at the reference-center-line display step S8 and at the reference head-position-trajectory drawing step S9. Furthermore, the B-axis with an error and the spindle center line with an error, and a trajectory of the head position of the center line in a case where the spindle center line with an error is rotated around the B-axis center line with an error are drawn (thick lines in FIG. 9) at the error-magnified center-line display step S10 and at the error-magnified head-position-trajectory drawing step S11. A trajectory that can be more intuitively understood is obtained when the head position in this case is a head position of a tool or an end of the spindle.

When a trajectory of a spindle center position (a pivot point, which is an intersection between the B-axis center line and the spindle center line when there is no error) at the height of the B-axis center line is also drawn as shown in FIG. 9, an influence of the translation error can be more easily understood.

An example in which assembly errors in a 5-axis machine tool having two rotation axes of the C-axis and the B-axis on the spindle side are displayed on a three-dimensional perspective graph by the error display method according to the present embodiment is shown in FIG. 10. In this case, the direction of the B-axis center line changes according to an angle of the C-axis, and the direction of the spindle center line changes according to angles of the two rotation axes of the C-axis and the B-axis. By the error display method according to the present embodiment, B-axis center lines at at least two C-axis angles, and trajectories of a head of the spindle center line in a case where the B-axis is rotated within a movable range at the at least two C-axis angles are displayed. In the example shown in FIG. 10, B-axis center lines and spindle center lines, and trajectories of the spindle head in the case where the B-axis is rotated when the C-axis is at zero degree and when the C-axis is at 90 degrees are displayed.

A C-axis center line with no error, a B-axis center line with no error, and a spindle center line with no error are displayed, and a trajectory of the head of the spindle center line in a case where the spindle center line with no error is rotated around the B-axis center line with no error is drawn (thin lines in FIG. 10) at the reference-center-line display step S8 and at the reference head-position-trajectory drawing step S9. Furthermore, a B-axis center line in a state where the B-axis with no error is rotated at a predetermined angle around the C-axis with no error, and a trajectory of the head of the spindle center line in a case where the spindle center line with no error is rotated around the B-axis center line within the movable range of the B-axis are drawn (thin lines in FIG. 10).

A C-axis center line with an error, a B-axis center line with an error, and a spindle center line with an error are displayed, and a trajectory of the head of the spindle center line in a case where the spindle center line with an error is rotated around the B-axis center line with an error is drawn (thick lines in FIG. 10) at the error-magnified center-line display step S10 and at the error-magnified head-position-trajectory drawing step S11. Furthermore, a B-axis center line in a state where the B-axis with an error is rotated at a predetermined angle around the C-axis with an error, and a trajectory of the head of the spindle center line in a case where the spindle center line with an error is rotated around the B-axis center line within the movable range of the B-axis are drawn (thick lines in FIG. 10).

When a tool head position or a spindle end is defined as the head position also in these cases, the trajectory can be understood more intuitively. Furthermore, when a trajectory of the spindle center position (a pivot point, which is an intersection between the B-axis center line and the spindle center line when there is no error) at the height of the B-axis center line is also drawn as shown in FIG. 10, influences of the translation error and the attitude error can be more easily understood.

As described above, with the error display device and the error display method according to the present embodiment, the states of assembly errors such as the position and the tilt of the center line of a rotation axis can be visually displayed and therefore characteristics of the assembly errors included in the rotation axes of a machine can be intuitively understood. Accordingly, correction of the assembly errors or examination of causes of a poor accuracy during machining can be performed.

Furthermore, when the direction of the rotation-axis center line on the table side or the spindle center line is changed due to a motion of the rotation axis on the root side as in the rotary-table type or the mixed type, behavior of the center line with an error when the center line is rotated around the rotation axis with an error can be visually displayed. Accordingly, the degrees of influences of assembly errors in plural rotation axes are recognized and errors that are to be strictly adjusted and other errors can be distinguished.

In addition, behaviors of the center line of the spindle with an error when the center line is rotated around two rotation axes can be visually displayed. This enables the degrees of influences of assembly errors in plural rotation axes to be recognized, so that errors that need to be strictly adjusted and other errors can be distinguished.

The methods for magnifying and displaying errors in six degrees of freedom associated with a motion of a rectilinear axis or assembly errors in rotation axes in various rotation axis configurations by the error display methods according to the present embodiments have been explained above. It is quite possible for persons skilled in the art to display errors in an axis configuration that is not explained in the embodiments by a similar method.

### INDUSTRIAL APPLICABILITY

As described above, the error display device and the error display method according to the present invention are suitable for an error display device and an error display method that magnify an assembly error of a machine element, for example, in a machine tool or a robot, or an error associated with a motion thereof and to display the error.

### REFERENCE SIGNS LIST

1 machine element that performs rectilinear motion

2 machine element that performs rotational motion

S1 error-data reading step

S2 reference-motion-trajectory display step (reference-motion-trajectory display unit)

S3 error magnification/display step (error magnification/display unit)

S4 translation-error-vector calculating step

S5 translation-error-trajectory display step

S6 attitude-error-matrix calculating step

S7 attitude-error display step

S8 reference-center-line display step (reference-center-line display unit)

S9 reference head-position-trajectory drawing step

S10 error-magnified center-line display step

S11 error-magnified head-position-trajectory drawing step

1. An error display device for displaying a translation error and an attitude error associated with a rectilinear motion of a machine element, the error display device comprising:
a reference-motion-trajectory display unit that displays a design motion trajectory; and
an error magnification/display unit that magnifies the translation error and the attitude error and displays the magnified errors, wherein
the error magnification/display unit
calculates a translation error vector including a magnified translation error obtained by multiplying the translation error by a predetermined magnification factor, and draws a translation error trajectory including the design motion trajectory and the translation error vector added thereto, and
calculates an attitude error matrix including a magnified attitude error obtained by multiplying the attitude error by a predetermined magnification factor, and draws a predetermined shape with coordinates transformed using the attitude error matrix and the translation error vector, and
display of a first line segment representing the design motion trajectory by the reference-motion-trajectory display unit, and display of a second line segment representing the translation error trajectory and of a plurality of third line segments representing the attitude error by the error magnification/display unit is performed on a same three-dimensional perspective graph,
the display of the first line segment, the display of the second line segment, and the display of the third line segments is performed on the three-dimensional perspective graph in forms that can be distinguished from each other, and
the third line segments each intersect with the second line segment and are arranged substantially at equal distances along the second line segment on the three-dimensional perspective graph.

2. The error display device according to claim 1, wherein the error magnification/display unit calculates the attitude error matrix and the translation error vector at at least two points with respect to one movable axis, and draws the second line segment and the third line segments.

3. The error display device according to claim 1, wherein the reference-motion-trajectory display unit and the error magnification/display unit set the magnification factor to a value between 100 and 1000, draw the design motion trajectory and the translation error trajectory to extend in a movement direction of the rectilinear motion on the three-dimensional perspective graph, and draw the predetermined shape showing the attitude error at a position corresponding to an actual measurement position along the translation error trajectory.

4. An error display device that displays a position and a tilt of a rotation-axis center line of a rotation axis of a machine element, the error display device comprising:
a reference-center-line display unit that draws a design center line of the rotation axis as a reference center line with a predetermined length of a line segment; and
an error magnification/display unit that draws an error-magnified center line including an assembly error magnified, wherein
the error magnification/display unit
calculates a translation error vector including a magnified translation error obtained by multiplying a translation error by a predetermined magnification factor, and calculates an attitude error matrix including a magnified attitude error obtained by multiplying an attitude error by a predetermined magnification factor, and
draws a line segment, which is obtained by transforming coordinates of the reference center line using the attitude error matrix and the translation error vector, as the error-magnified center line; and
the machine element has a first rotation axis, and a second rotation axis having a center line a direction of which is changed by a motion of the first rotation axis,
the reference-center-line display unit calculates a reference head position that is a predetermined point on a reference center line of the second rotation axis corresponding to a rotation angle of the first rotation axis within a movable range of the first rotation axis, and draws a trajectory of the reference head position, and
the error magnification/display unit
calculates an error-magnified head position that is a predetermined point on the center line of the second rotation axis corresponding to the rotation angle of the first rotation axis within the movable range of the first rotation axis, based on the attitude error matrix and the translation error vector of the first rotation axis and the attitude error matrix and the translation error vector of the second rotation axis, and
draws a trajectory of the error-magnified head position.

5. (canceled)

6. The error display device according to claim 4, wherein the second rotation axis is a rotary table.

7. The error display device according to claim 4, wherein the second rotation axis is a spindle, and the predetermined point on the center line of the second rotation axis is a spindle end or a tool head.

8. The error display device according to claim 4, wherein
the machine element has a first rotation axis, a second rotation axis having a center line a direction of which is changed by a motion of the first rotation axis, and a third rotation axis having a center line a direction of which is changed by a motion of the second rotation axis,
the reference-center-line display unit
draws a reference center line of the second rotation axis at each of two or more angles of the first rotation axis within a movable range of the first rotation axis,
calculates a reference head position that is a predetermined point on a reference center line of the third rotation axis corresponding to a rotation angle of the second rotation axis within a movable range of the second rotation axis at each of the angles of the first rotation axis, and
draws a trajectory of the reference head position,
the error magnification/display unit calculates an attitude error matrix and a translation error vector at each of the two or more angles within the movable range of the first rotation axis based on the attitude error matrix and the translation error vector of the first rotation axis and the attitude error matrix and the translation error vector of the second rotation axis to transform coordinates of a reference center line of the second rotation axis, and draws an error-magnified center line of the second rotation axis for each of the angles of the first rotation axis, and
the error magnification/display unit also
calculates an error-magnified head position that is a predetermined point on a center line of the third rotation axis within the movable range of the second rotation axis for each of the angles of the first rotation axis based on the attitude error matrix and the translation error vector of the first rotation axis, the attitude error matrix and the translation error vector of the second rotation axis, and the attitude error matrix and the translation error vector of the third rotation axis, and
draws a trajectory of the error-magnified head position.

9. The error display device according to claim 8, wherein the third rotation axis is a spindle, and the predetermined point on the center line of the third rotation axis is a spindle end or a tool head.

10. The error display device according to claim 4, wherein the reference-center-line display unit and the error magnification/display unit draw a line segment representing the reference center line and the error-magnified center line on a three-dimensional perspective graph, while setting a coordinate system to show the error-magnified center line to be tilted in an error direction with respect to the reference center line and setting the magnification factor to a value between 100 and 1000.

11. An error display method for displaying a translation error and an attitude error associated with a rectilinear motion of a machine element, the error display method comprising:
a reference-motion-trajectory display step of displaying a design motion trajectory; and
an error magnification/display step of magnifying the translation error and the attitude error and displaying the magnified errors, wherein
at the error magnification/display step,
a translation error vector including a magnified translation error obtained by multiplying the translation error by a predetermined magnification factor is calculated, and a translation error trajectory including the design motion trajectory and the translation error vector added thereto is drawn, and
an attitude error matrix including a magnified attitude error obtained by multiplying the attitude error by a predetermined magnification factor is calculated, and a predetermined shape with coordinates transformed using the attitude error matrix and the translation error vector is drawn,
display of a first line segment representing the design motion trajectory at the reference-motion-trajectory display step, and display of a second line segment representing the translation error trajectory and of a plurality of third line segments representing the attitude error at the error magnification/display step is performed on a same three-dimensional perspective graph,
the display of the first line segment, the display of the second line segment, and the display of the third line segments is performed on the three-dimensional perspective graph in forms that can be distinguished from each other, and
the third line segments each intersect with the second line segment and are arranged substantially at equal distances along the second line segment on the three-dimensional perspective graph.

12. The error display method according to claim 11, wherein at the error magnification/display step, the attitude error matrix and the translation error vector are calculated at at least two points with respect to one movable axis, and the second line segment the third line segments are drawn.

13. The error display method according to claim 11, wherein at the reference-motion-trajectory display step and at the error magnification/display step, the magnification factor is set to a value between 100 and 1000, the design motion trajectory and the translation error trajectory are drawn on the three-dimensional perspective graph to extend in a movement direction of the rectilinear motion, and the predetermined shape showing the attitude error is drawn at a position corresponding to an actual measurement position along the translation error trajectory.

14. An error display method of displaying a position and a tilt of a rotation-axis center line of a rotation axis of a machine element, the error display method comprising:
a reference-center-line display step of drawing a design center line of the rotation axis as a reference center line with a predetermined length of a line segment; and
an error magnification/display step of drawing an error-magnified center line including an assembly error magnified, wherein
at the error magnification/display step,
a translation error vector including a magnified translation error obtained by multiplying a translation error by a predetermined magnification factor is calculated, and an attitude error matrix including a magnified attitude error obtained by multiplying an attitude error by a predetermined magnification factor is calculated, and
a line segment obtained by transforming coordinates of the reference center line using the attitude error matrix and the translation error vector is drawn as the error-magnified center line, and
when the machine element has a first rotation axis, and a second rotation axis having a center line a direction of which is changed by a motion of the first rotation axis,
at the reference-center-line display step, a reference head position that is a predetermined point on a reference center line of the second rotation axis corresponding to a rotation angle of the first rotation axis within a movable range of the first rotation axis is calculated, and a trajectory of the reference head position is drawn, and
at the error magnification/display step, an error-magnified head position that is a predetermined point on the center line of the second rotation axis corresponding to the rotation angle of the first rotation axis within the movable range of the first rotation axis is calculated, based on the attitude error matrix and the translation error vector of the first rotation axis and the attitude error matrix and the translation error vector of the second rotation axis, and a trajectory of the error-magnified head position is drawn.

15. (canceled)

16. The error display method according to claim 14, wherein the second rotation axis is a rotary table.

17. The error display method according to claim 14, wherein the second rotation axis is a spindle, and the predetermined point on the center line of the second rotation axis is a spindle end or a tool head.

18. The error display method according to claim 14, wherein
when the machine element has a first rotation axis, a second rotation axis having a center line a direction of which is changed by a motion of the first rotation axis, and a third rotation axis having a center line a direction of which is changed by a motion of the second rotation axis,
at the reference-center-line display step, a reference center line of the second rotation axis at each of two or more angles of the first rotation axis within a movable range of the first rotation axis is drawn, a reference head position that is a predetermined point on a reference center line of the third rotation axis corresponding to a rotation angle of the second rotation axis within a movable range of the second rotation axis at each of the angles of the first rotation axis is calculated, and a trajectory of the reference head position is drawn,
at the error magnification/display step, an attitude error matrix and a translation error vector at each of the two or more angles within the movable range of the first rotation axis are calculated, based on the attitude error matrix and the translation error vector of the first rotation axis and the attitude error matrix and the translation error vector of the second rotation axis to transform coordinates of a reference center line of the second rotation axis, and an error-magnified center line of the second rotation axis at each of the angles of the first rotation axis is drawn, and
an error-magnified head position that is a predetermined point on the center line of the third rotation axis within the movable range of the second rotation axis at each of the angles of the first rotation axis is also calculated based on the attitude error matrix and the translation error vector of the first rotation axis, the attitude error matrix and the translation error vector of the second rotation axis, and the attitude error matrix and the translation error vector of the third rotation axis, and a trajectory of the error-magnified head position is drawn.

19. The error display method according to claim 18, wherein the third rotation axis is a spindle, and the predetermined point on the center line of the third rotation axis is a spindle end or a tool head.

20. The error display device according to claim 14, wherein at the reference-center-line display step and the error magnification/display step, a line segment representing the reference center line and the error-magnified center line are drawn on a three-dimensional perspective graph, while setting a coordinate system to show the error-magnified center line to be tilted in an error direction with respect to the reference center line and setting the magnification factor to a value between 100 and 1000.
